(19) United States
(12) Patent Application Publication
(10) Pub. No.: US 2017/0183757 A1
(43) Pub. Date: Jun. 29, 2017

(54) HOT STAMPING METHOD FOR MANUFACTURING VEHICLE BODY PARTS

(71) Applicant: MS AUTOTECH CO., LTD., Gyeongju-si (KR)

(72) Inventors: Sung Ung KIM, Gyeongju-si (KR); Hyun Woo LEE, Suwon-si (KR); Jang Soo KIM, Gwacheon-si (KR)

(73) Assignee: MS AUTOTECH CO., LTD., Gyeongju-si (KR)

(21) Appl. No.: 15/460,889

(22) Filed: Mar. 16, 2017

Related U.S. Application Data
(63) Continuation-in-part of application No. 12/496,254, filed on Jul. 1, 2009, now Pat. No. 9,631,248.

(30) Foreign Application Priority Data
Oct. 2, 2008 (KR) 10-2008-0096912

(51) Int. Cl. C21D 9/46; C21D 8/02; C21D 1/673; F27B 9/24; H05B 6/10; B21D 22/02; B21D 53/88; F27B 9/06; C21D 9/00; C21D 1/42

(52) U.S. Cl. CPC C21D 9/46; C21D 9/0062; C21D 8/0221; C21D 1/673; C21D 1/42; H05B 6/101; B21D 22/022; B21D 53/88; F27B 9/067; F27B 9/2407; C21D 2211/005; C21D 2211/009

(57) ABSTRACT

Provided is a hot stamping method for manufacturing high strength vehicle body parts. The hot stamping method includes: high frequency induction heating a blank in a first heating furnace while transferring the blank; heating the heated blank to an austenitization temperature or more of a corresponding blank while transferring the heated blank from the first heating furnace to a second heating furnace; and drawing the blank heated to the austenitization temperature or more in the second heating furnace to form and cool the blank by using a press forming apparatus. According to the hot stamping method, it is possible to achieve excellent productivity and reduce energy.

### CROSS-REFERENCE TO RELATED APPLICATION

This application is a continuation-in-part of U.S. application Ser. No. 12/496,254 filed on Jul. 1, 2009, the disclosure of which is incorporated herein in its entirety by reference, which is based on and claims the benefit of Korean Patent Application No. 10-2008-0096912, filed on Oct. 2, 2008, the disclosure of which is incorporated herein in its entirety by reference.

### BACKGROUND OF THE INVENTION

The present invention relates to a hot stamping method used in sheet metal forming, specifically in production of high-strength steel components for crash-relevant parts in the automotive industry.

Lightweight and high-strength body is a main issue in the automotive industry. The hot stamping technology was proposed by Norrbottens Jarnverk AB in Sweden in the early 1970s. In GB Patent No. 1490535 issued to this company, the hot stamping technology is disclosed in detail.

To obtain a vehicle body part having tensile strength of 1 GPa or more by the hot stamping process, the microstructure of a steel blank has to be transformed from austenite to martensite by the quenching process in a press forming apparatus. For the hot stamping, boron steels are used which contains carbon of about 0.2 wt % and uses manganese (Mn) and boron (B) as elements for improving heat treatment performance.

In the hot stamping process, the blank is heated to an austenitization temperature or more, for example, up to 950° C., and then formed in a press forming apparatus, which provides excellent formability and reduces spring-back or delayed fracture, particularly in high-strength parts.

During the hot stamping process, however, surface oxidation of the blank is occurred, and thus oxide scale on the surface of the hot-pressed body part needs to be removed through a descaling process. In order to remove the descaling process, aluminized steel sheets were proposed by Arcelormittal.

For the hot stamping, the blank may be heated in an electric resistance furnace to a temperature between 880° C. and 950° C. to form austenite. The electric resistance furnace may have heating elements provided in its walls and an electric current is directed through the heating elements where it is dissipated as heat. The thermal energy is transferred to the blank by radiation and convection. It takes between 12 minutes and 17 minutes to austenitize a blank of 1.2 mm thick using the electric resistance furnace or a gas furnace, which causes decrease the operating speed and increases the production cost of the hot stamping. Furthermore, the length of the heating furnace when using the electric resistance furnaces and the gas furnaces needs to be extended for the hot stamping, ranging from 23 m to 30 m. This means that large space-based facilities are needed for the hot stamping.

### SUMMARY

High frequency induction heating may be used for local strengthening of vehicle body parts. A steel body part may be heated up to 1000° C. or more within several seconds by the high frequency induction heating. If it is possible to use the high frequency induction heating for the hot stamping, the length of the heating furnace and the heating time to austenitize blanks can be reduced. Such a fast temperature increase by the high frequency induction heating, however, may cause deformation of the blank. The high frequency induction heating was merely used just for a heat treatment of thick or bulky steel products rather than thin steel sheets for the hot stamping.

The present invention proposes a hybrid heating system having a high frequency induction heating furnace for the hot stamping. High frequency induction heating for press-forming thin steel sheets having a thickness about 0.7 mm to about 1.2 mm has never been adapted before and has never been considered to be possible. The present invention is to overcome the stereotype view and propose an innovative alternative that is able to replace the electric resistance furnace for the hot stamping.

U.S. Pat. No. 5,922,234 discloses technology for induction heating a slab while transferring the slab by using a roller. However, the slab commonly has a thickness of 50 mm to 300 mm and a very long length. The slab is a bulky metal product having a weight of 10 tons or more, furthermore, 50 tons or more and is obviously different from a blank used in hot stamping according to the present invention.

The blank is obtained by blanking a cold rolled coil or a parent material having a sheet shape so as to have a size and a shape required for hot stamping. The blank may be a thin sheet having a thickness of 2 mm or less, mostly, a thickness of about 0.7 mm to about 1.2 mm.

U.S. Pat. No. 5,487,795 discloses technology for heating an impact beam using high frequency induction devices while transferring the impact beam on transfer rollers. However, the impact beam induction-heated in the U.S. Pat. No. 5,487,795 is a bulky metal product previously formed. The impact beam is obviously different from a blank heated for hot stamping in the present invention.

The high frequency induction heating was not used or proposed for hot stamping at the time of filing U.S. application Ser. No. 12/496,254 and Korean Patent Application No. 10-2008-0096912.

A hot stamping method according to the present invention includes: performing a high frequency induction heating on a blank in a first heating furnace while transferring the blank; heating the blank transferred from the first heating furnace while transferring the blank in a second heating furnace; and forming and cooling the blank transferred from the second heating furnace in a press forming apparatus

According to an embodiment, the first heating furnace is surrounded by a housing which may minimize heat loss. However, the heat loss may occur in a portion not completely sealed, in particular, at an inlet of the first heating furnace through which the blank is introduced. The blank is not intentionally cooled during the high frequency induction heating.

According to an embodiment, the blank is continuously transferred without stopping in the high frequency induction heating in the first heating furnace. The blank is transferred by rollers arranged in a moving direction of the blank. When the blank stops on the rollers in the first heating furnace, a portion of the blank, which contacts the rollers, may be locally cooled. A portion of the blank between the rollers may be sagged.

According to an embodiment, the first heating furnace may have at least two heating zones in a transfer direction of the blank, the at least two heating zones being controlled at different target temperatures and different heating rates. The blank may be pre-heated at a lower power level, desirably, heated to a temperature of 250° C. in a first heating zone and may be rapidly heated at a higher power level, desirably, heated to a temperature less than 550° C. in a second heating zone. According to such a heating pattern, deformation or distortion of the blank may be prevented even when temperature sharply rises due to the high frequency induction heating. An inverter and an inductor coil independently controlled are installed in each of the first and second heating zones.

U.S. application Ser. No. 12/496,254 and Korean Patent Application No. 10-2008-0096912 do not emphasize or exactly specify that upper rollers are not provided so as to transfer a blank. However, it is necessary to pay attention that these Applications discloses a feature that deformation of a steel sheet occurring in induction heating is controllable through a space adjustment between an upper roller and a lower roller.

According to an embodiment, the second heating furnace may be an indirect heating furnace, in particular, an electric resistance furnace or a gas furnace, which transfers heat energy to the blank though at least one of radiation and convection. For example, the electric resistance furnace indirectly heats the blank by applying a current to heating elements installed on a furnace wall. The gas furnace uses radiant tubes. The blank may be heated to an austenitization temperature of the blank or more in the second heating furnace.

According to an embodiment, the press forming apparatus includes an upper die and a lower die, which each include a cooling channel formed therein. A high strength body part having a martensite structure is manufactured by forming and quenching the blank heated to the austenitization temperature or more in the second heating furnace

According to embodiments of the present invention, the length and the space for the heating system can be reduced by 50% or more compared to the related art, and the production cost of hot stamping can be significantly reduced.

According to the hot stamping method of the present invention, it is possible to cost-effectively provide a high strength vehicle body part having excellent quality.

### BRIEF DESCRIPTION OF THE DRAWINGS

Embodiments of the present invention will be more clearly understood from the following detailed description taken in conjunction with the accompanying drawings in which:

FIG. 1 is a block diagram of a hot stamping process according to an embodiment of the present invention;

FIG. 2 is a schematic diagram of apparatuses in a process order, which are used in a hot stamping process, according to an embodiment of the present invention;

FIG. 3 is a diagram illustrating a pair of upper and lower rollers provided in a first heating furnace, according to an embodiment of the present invention;

FIG. 4 is a diagram illustrating lower rollers and induction coils provided in a first heating furnace, according to an embodiment of the present invention;

FIG. 5 is a diagram illustrating a placement of a pair of upper and lower rollers and an induction coil according to an embodiment of the present invention;

FIG. 6 is a schematic cross-sectional view taken along line VI-VI of FIG. 4;

FIG. 7 is a diagram illustrating a transit section according to an embodiment of the present invention; and

FIG. 8 is a diagram illustrating an example in which a position of a blank introduced into the transit section shown in FIG. 7 is regulated by guide pins.

### DETAILED DESCRIPTION OF THE EMBODIMENTS

Hereinafter, the present invention will be described in detail with reference to the accompanying drawings Like reference numerals refer to like elements for convenience of description.

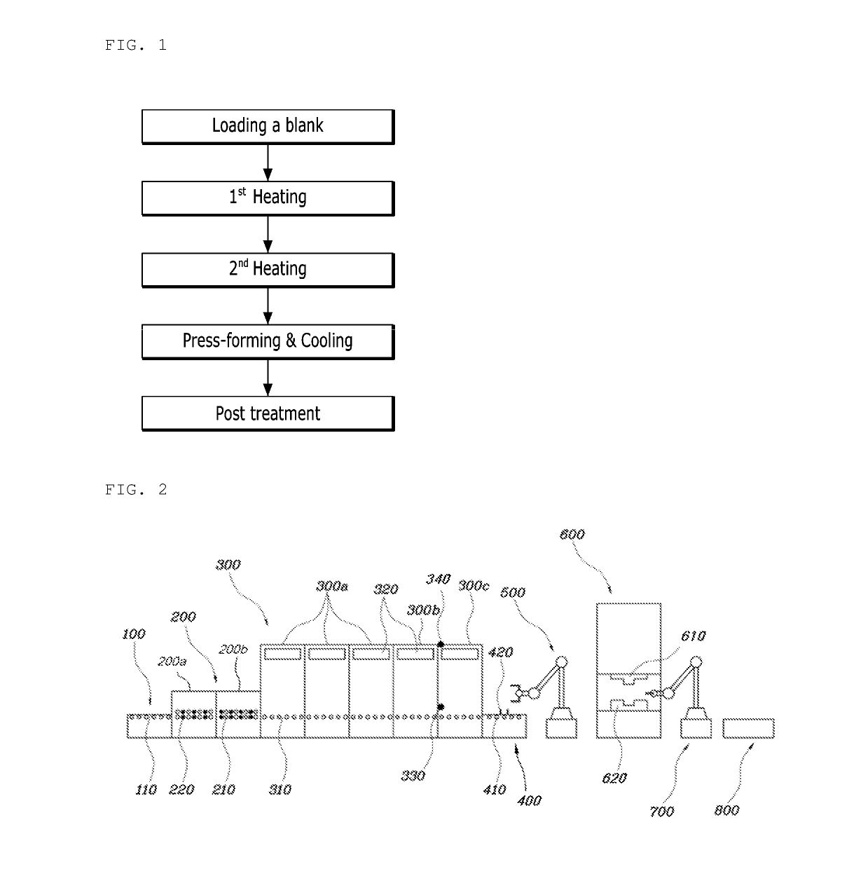

A hot stamping process and apparatuses used therein according to an embodiment of the present invention will be described with reference to FIGS. 1 and 2.

Referring to FIGS. 1 and 2, the hot stamping process includes heating a blank in a heating system, forming and cooling the heated blank in a press forming apparatus 600, and loading the press-formed blank onto a conveyor 800. Transfer robots 500 and 700 are positioned to transfer the blank between the heating system and the press forming apparatus 600, and between the press forming apparatus 600 and the conveyor 800, respectively.

The heating system includes a feed section 100, first and second heating furnaces 200 and 300, and a transit section 400.

As shown in FIG. 2, the feed section 100 includes a plurality of feed rollers 110 arranged in a transfer direction of the blank to feed the blank to the first heating furnace 200. The length of the feed section 100 may be adjusted according to a size of the blank to be fed, and as needed, the feed rollers 110 may be made of stainless steel.

As shown in FIG. 2, the first heating furnace 200 is a high-frequency induction furnace having two heating zones 200a and 200b. The target temperatures of heating the blank in the two heating zones 200a and 200b are different from each other. Each heating zone is provided with induction coils 220 connected to a separate inverter (not shown). Output of the inverter may be adjusted through a frequency modulation.

The target temperature of the first heating zone 200a using a relatively low frequency may be 250° C. and the target temperature of the second heating zone 200b using a relatively high frequency may be 550° C. or less. By heating the blank using the two heating zones, it is possible to prevent or suppress deformation or distortion of the blank caused by a sharp increase in temperature.

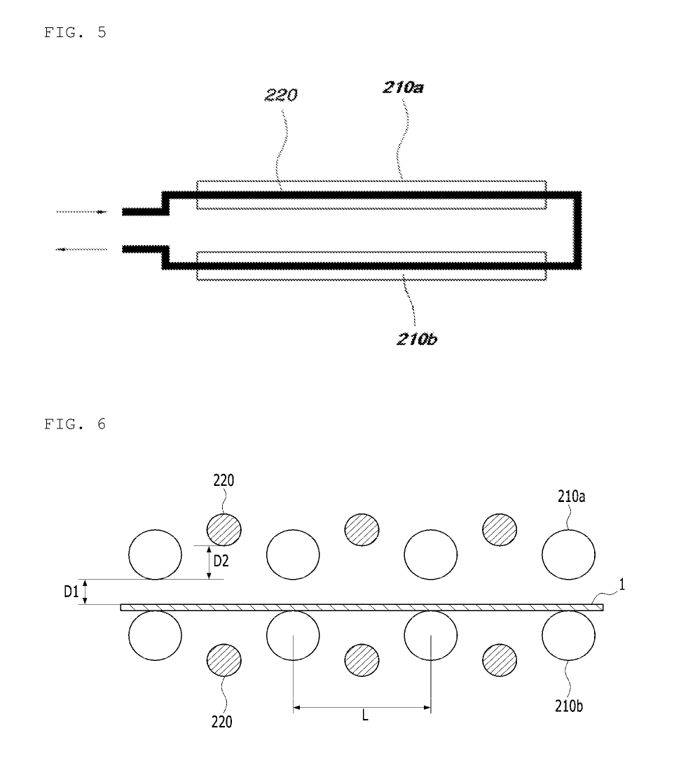

As shown in FIGS. 2 to 4, in the first heating furnace 200, a plurality of pairs of upper and lower rollers 210 for transferring the blank are arranged in a lengthwise direction of the first heating furnace 200, and the induction coils 220 are alternately arranged with the pairs of upper and lower rollers 210 in the lengthwise direction of the first heating furnace 200. Referring to FIG. 5, the induction coil 220 may continuously extend from an upper side between the upper rollers 210a to a lower side between the lower rollers 210b. The induction coils 220 are insulated and/or coated to avoid the spark caused by contact with the blank.

The blank is transferred by the lower rollers 210b which are rotated. The upper rollers 210a are not provided to transfer the blank. When the blank is not deformed, the upper rollers 210a do not contact the blank.

Referring to FIG. 6, the upper rollers 210a are arranged so as to be spaced apart from a blank 1 by a certain distance D1. When the blank 1 is deformed in a thickness direction thereof in high frequency induction heating, the certain distance D1 is set to a distance capable of suppressing or blocking the deformation of the blank 1 to a certain degree or less. Desirably, the certain distance D1 is 30 mm to 40 mm. The induction coils 220 may be spaced apart from the blank 1 by a distance (=distance D1+distance D2) in a rear of the upper and lower rollers 210 such that the blank 1 does not contact the induction coils 220.

The upper rollers 210a rotate together with the lower rollers 210b, at least while the blink 1 is transferred by the lower rollers 210b. The upper rollers 210a rotate in a direction opposite to a rotation direction of the lower rollers 210b, i.e., a direction in which the transferred blank 1 moves forward. After the blank 1 is blocked by the upper rollers 210a, the rotating upper rollers 210a allow the blank 1 to smoothly move in a transfer direction and allow additional problems not to occur.

When a deformation degree of a blank is properly controlled in the high frequency induction heating, some degree of the deformation in the blank may be alleviated to a negligible degree in a subsequent heating process.

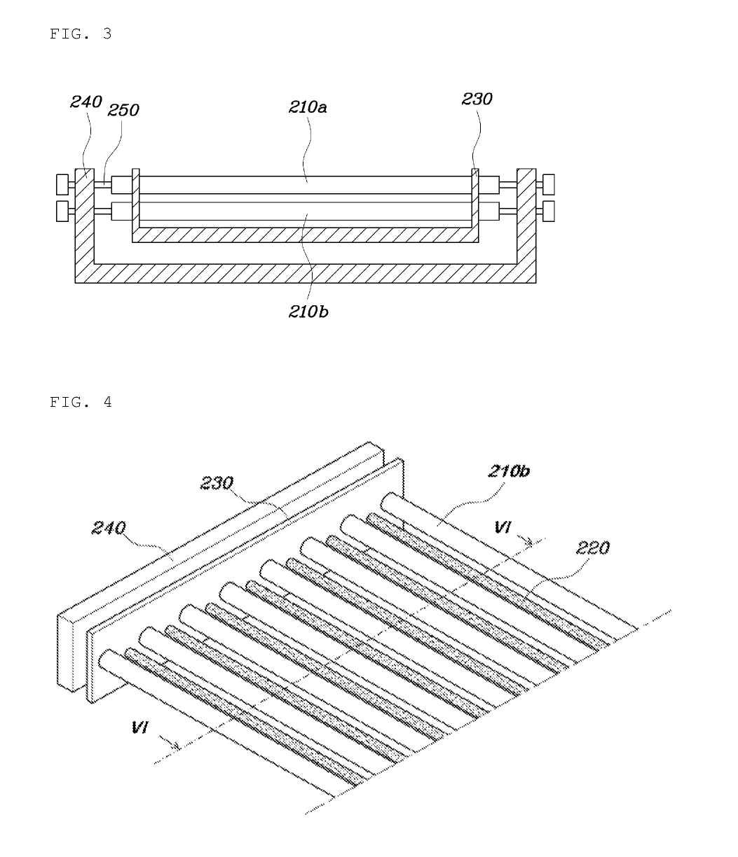

The transfer speed of the blank in the first heating furnace 200 is controlled within a range from 70 mm/sec to 90 mm/sec. Referring to FIGS. 3 to 5, both ends of the upper and lower rollers 210a and 210b pass through insulation panels 230 and then mounted on Bakelite panels 240 which forms the housing of the first heating furnace 200. The Bakelite panels 240 are used for shielding the influence of high frequency as well as insulation and strength of the housing. The both ends of the upper and lower rollers 210a and 210b passing through these

Bakelite panels 240 are connected with drive units for rotating the upper and lower rollers 210a and 210b. Dampers may be provided with the drive units, particularly in bearings to which the upper rollers 210a are connected to absorb the impact from the blank passing on the lower rollers 210b.

The upper and lower rollers 210a and 210b are made of a hollow ceramic material for insulation and have extensions 250 to connect the upper and lower rollers 201a and 210b to drive units.

The second heating furnace 300 may be an indirect heating furnace. An electric resistance furnace or a gas furnace may be used for the second heating furnace 300. The blank may be heated to a temperature of Ac3 or more of the blank (about 950° C.) in the second heating furnace 300.

As shown in FIG. 2, the second heating furnace 300 has five heating zones. The front three heating zones may constitute a heating section 300a for heating the blank to a temperature of Ac3 or more. The forth heating zone may be a soaking section 300b to make sure that the blank is heated uniformly. The fifth heating zone may be a standby section 300c to confirm that the blank is fully heated and discharge it at high speed for press-forming. For indirect heating, heating elements 320 are placed apart from the blank being transferred in the second heating furnace 300. The heating elements 320 can be provided on the top wall of the second heating furnace 300.

As shown in FIG. 2, transfer rollers 310 for transferring the blank are arranged along the second heating furnace 300. The standby section 300c of the second heating furnace 300 is followed by the transit section 400 having conveyer rollers 410.

A blank position detection sensor 330 and a temperature detection sensor 340 are positioned in the standby section 300c. The position detection sensor 330 for detecting whether or not the blank enters the standby section 300c and is placed in the standby section 300c throughout the entire length thereof. The temperature detection sensor 340 is for confirming if the blank entered into the standby section 300c is sufficiently heated up to 950° C.

The transfer speed of the blank in the heating section 300a is equal to that in the soaking section 300b. The transfer speed of the blank in the standby section 300c is also equal to those in the heating and soaking sections 300a and 300b before the blank is discharged from the standby section 300c. When it is confirmed that the blank completely enters the standby section 300c and is heated, the transfer speed of the blank in the standby section 300c increases and the blank is discharged to the transit section 400. The discharging timing may be determined on the basis of information from the position and temperature detection sensors 330 and 340. After the blank is discharged from the standby section 300c, the transfer speed thereof is gradually reduced to be equal to those for the heating and soaking sections 300a and 300b.

The temperature of the blank decreases rapidly in several seconds until the blank is formed in the press forming apparatus 600 after being discharged from the standby section 300c.

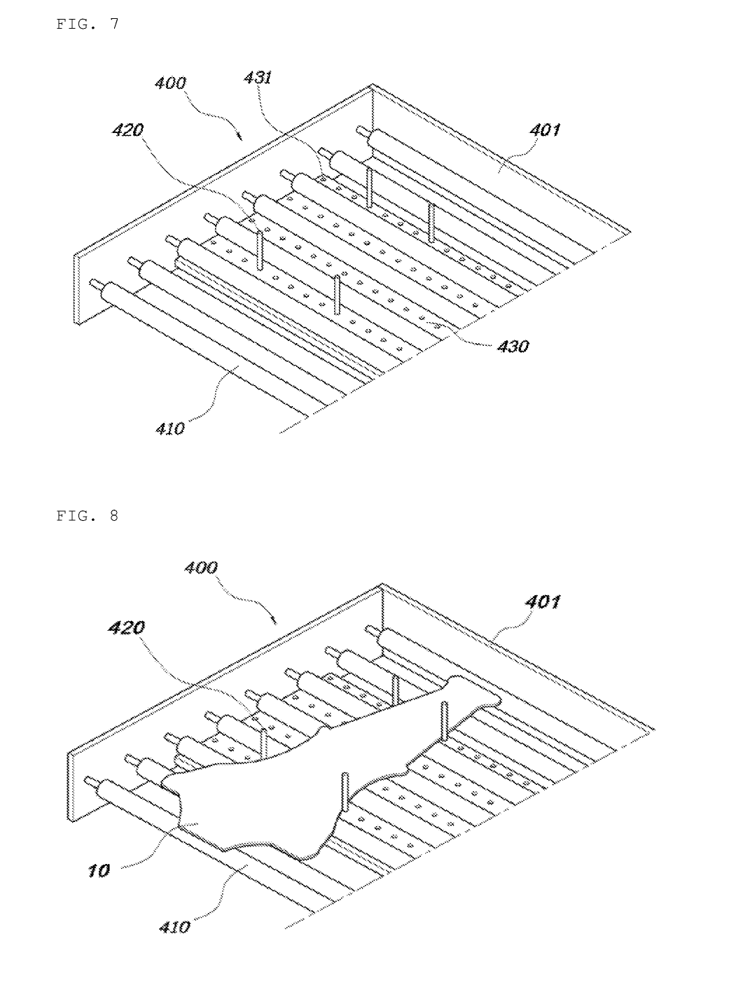

Referring FIGS. 7 and 8, guide pins 420 are installed upwards between the neighboring conveyer rollers 410 to guide the blank in a right position. The conveyer rollers 410 rotate to move the blank and continue to rotate as long as the blank is thereon. The conveyer rollers 410 rotate while the blank is stopped by the guide pins 420. This continuous rotation of the conveyer rollers 410 prevents local temperature reduction, deformation, etc. of the blank. A support plate 430 may be placed below the conveyer rollers 410 and movable in an up-and-down direction. A plurality of mounting holes 431 for the guide pins 420 is formed in the support plate 430 along the axial direction of the conveyer rollers 410. The support plate 430 is connected to a frame 401 of the transit section 400.

As shown in FIG. 2, the blank on the transit section 400 is transferred to the press forming apparatus 600 having upper and lower dies 610 and 620, and then formed and heat-treated. The upper and lower dies 610 and 620 are each provided with cooling channels for heat treatment of the blank. The hot-formed product is discharged and loaded on the conveyor 800 by the second transfer robot 600.

As shown in FIG. 1, the hot stamping process according to the embodiment includes a first heating process, a second heating process, a press-forming and cooling process, and a post treatment process. An example of the post treatment process is to trim an edge of a part which is press-formed and cooled.

Boron steel having an aluminium alloy coating layer may be used as a material of the blank used in the hot stamping process according to the embodiment. In an example, the material of the blank may include 0.4 wt % or less of carbon (C), 0.5 wt % to 2.0 wt % of manganese (Mn), and 0.0005 wt % to 0.1 wt % of boron (B). Furthermore, the material of the blank may be boron steel including 0.2 wt % to 0.25 wt % of carbon (C), 1.10 wt % to 1.35 w % of manganese (Mn), 0.15 wt % to 0.35 wt % of silicon (Si), 0.15 wt % to 0.30 wt % of chrome (Cr), 0.02 wt % to 0.06 wt % of aluminium (Al), 0.002 wt % to 0.004 wt % of boron (B), 0.02 wt % to 0.05 wt % of titanium (Ti), and 0.008 wt % or less of sulphur (S).

The austenitization temperature may be A3 temperature of the boron steel at which a mixture phase of ferrite and austenite is converted into a single phase. The boron steel sheets may have a mixture phase of pearlite and ferrite at room temperature.

While the present invention has been shown and described in connection with the exemplary embodiment, it will be apparent to those skilled in the art that modifications and variations can be made without departing from the spirit and scope of the invention as defined by the appended claims.

What is claimed is:

1. A hot stamping method for manufacturing vehicle body parts, the hot stamping method comprising:
a) performing a high frequency induction heating on a blank in a first heating furnace while transferring the blank, wherein the blank is obtained by blanking a boron steel sheet so as to have a size and a shape required for hot stamping and is not intentionally cooled in the high frequency induction heating;
b) heating the blank transferred from the first heating furnace while transferring the blank in a second heating furnace, wherein the second heating furnace is a indirect heating furnace configured to transfer heat energy to the blank through at least one of radiation and convection; and
c) forming and cooling the blank transferred from the second heating furnace in a press forming apparatus, wherein the press forming apparatus comprises an upper die and a lower die each having a cooling channel formed therein.

2. The hot stamping method of claim 1, wherein the first heating furnace comprises pairs of upper and lower rollers arranged in a transfer direction of the blank,
wherein the blank is transferred by the lower rollers and the upper rollers are spaced apart from the blank so as not to contact the blank while the blank is transferred,
a separation distance between the upper rollers and the blank is set so a distance capable of restraining deformation of the blank when the deformation occurs during the high frequency induction heating, and
the upper rollers are rotated in a direction capable of forwarding the blank in the transfer direction thereof.

3. The hot stamping method of claim 1, wherein the blank is heated to a temperature less than 550° C. by the a high frequency induction heating in the first heating furnace, and
the blank is heated to an austenitization temperature of the blank or more in the second heating furnace.

4. The hot stamping method of claim 2, wherein a transit section is followed by the second heating furnace,
wherein the transit section comprises conveyer rollers arranged in a moving direction of the blank discharged from the second heating furnace; and
guide pins disposed between the conveyer rollers and protruding above the conveyer rollers so as to regulate a position of the blank placed thereon,
wherein the conveyer rollers are controlled to rotate while the blank is placed thereon.
